(19) United States
(12) Patent Application Publication
(10) Pub. No.: US 2012/0001446 A1
(43) Pub. Date: Jan. 5, 2012

(54) TRIM COMPONENT COMPRISING FASTENING MEANS

(75) Inventor: Raphael Vollet, Ollainville (FR)

(73) Assignee: Renault S.A.S., Boulogne Billancourt (FR)

(21) Appl. No.: 13/203,394

(22) PCT Filed: Feb. 2, 2010
(86) PCT No.: PCT/FR2010/050166

§ 371 Date: Sep. 20, 2011

(30) Foreign Application Priority Data
Feb. 27, 2009 (FR) 0951263

(51) Int. Cl. B60R 13/02

(52) U.S. Cl. 296/1.08

(57) ABSTRACT

A trim component made of injection-molded plastic, including a substantially flat part directed along a reference plane, an internal face including at least one fastening mechanism, the fastening mechanism including a bridge of mid-plane, to support a clip and including two side walls opposite with respect to the mid-plane and joined together by a clip support wall. The side walls of the bridge includes, on their external faces, ribs, one end of which extends projecting from a plane defined by an edge of the side walls which is an opposite edge to the clip support wall, and is connected to the internal face of the trim component such that a space is created between the plane and the internal face of the trim component.

The invention relates to a trim component made of injection-molded plastic, comprising a substantially planar part directed along a given reference plane, an internal face of which is equipped with at least one fastening means, the fastening means consisting of a bridge of median plane, able to support a clip and having two side walls which are opposite one another with respect to the median plane and joined together by a clip support wall.

Such trim components are found more particularly in the field of motor vehicle door trim strips.

Door trim strips comprising an integrated clip holder and a smooth and painted surface often exhibit appearance defects resulting from the design of the clip holder.

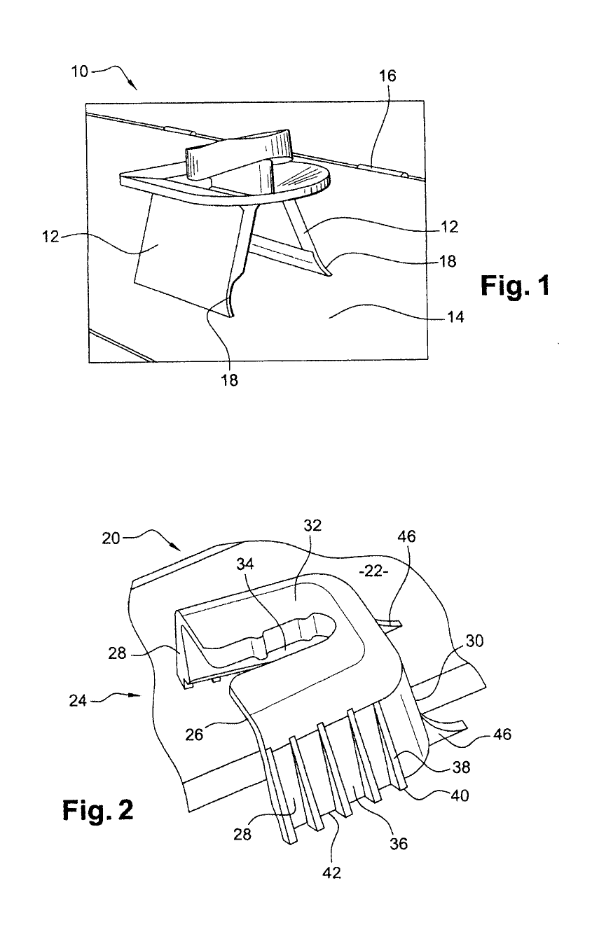

As depicted in FIG. 1, the clip holder 10 of the prior art comprises side walls 12 connected to an internal face 14 of a trim strip 16 by a thin web 18. However, the shrinkage of the material locked in this region by the mold packing piece (not depicted), causes the component to deform at the time of demolding. Shrinkage marks may also occur if the ratio between the thickness of the trim strip and the thickness of the clip holder is not optimized. It would therefore appear to be difficult to use such a clip holder, because of the limited possibilities of keeping the packing piece in position during molding and because of the appearance defects.

Alternative solutions involve fixing the clip holders in position using adhesive, or alternatively welding them or staking and heading them. However, these solutions have the disadvantage of being expensive.

In order to alleviate these disadvantages, the subject of the invention is a trim component comprising at least one fastening means of which the design, which is simple and inexpensive, is able to avoid appearance defects.

To this end, the invention proposes a trim component of the abovementioned type, characterized in that the side walls of the bridge comprise, on their external faces, ribs one end of which extends as a projection with respect to a plane defined by an edge of the side walls which is at the opposite end to the clip support wall and is connected to the internal face of the trim component in such a way that a space is left between the plane defined by the edge of the side walls and the internal face of the trim component.

According to other features of the invention:
the ribs are oriented in transverse planes that are substantially perpendicular to the median plane and to the reference plane.

the side walls are joined together by an end wall, a space being left between one edge of the end wall and the internal face of the component.

the ribs are thinner in their region of connection to the internal face of the trim component, an internal part of said ribs exhibiting a cutout.

the side walls of the bridge are extended by an additional rib oriented substantially parallel to the median plane.

the additional rib is positioned near the end wall.

the plane R defined by the edges of the side walls forms an angle with the reference plane of the component, to make demolding easier.

Other features and advantages of the invention will become apparent from reading the description of some exemplary embodiments of a trim component with reference to the attached drawings in which:

FIG. 1 is a perspective view of a component comprising a fastening means according to the prior art.

FIG. 2 is a perspective view of a component comprising a fastening means according to the invention.

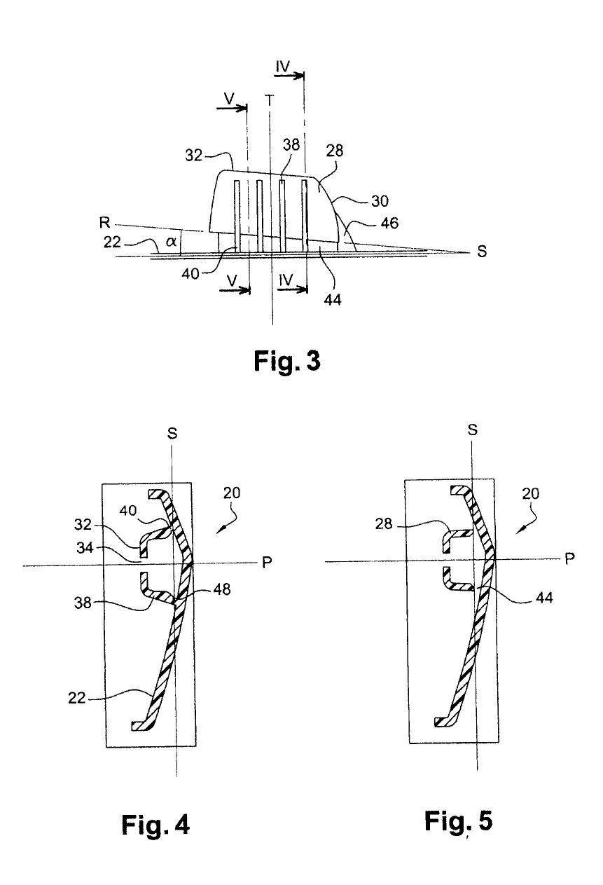

FIG. 3 is a side view of the component of FIG. 2.

FIG. 4 is a view of the component of FIG. 3 in section on IV-IV.

FIG. 5 is a view of the component of FIG. 3 in section on V-V.

As depicted in FIGS. 2 and 3, an injection-molded plastic trim component 20 has a substantially planar surface. The surface of the component may also be curved, but, for practical reasons, we shall adopt a plane S as our reference.

The trim component 20, may, for example, be a side trim strip intended to be fitted to the door of a motor vehicle.

The trim component 20 comprises, on its internal face 22, a fastening means 24 which consists of a bridge 26 of median plane P, intended to carry a fastening clip (not depicted).

The bridge 26 has two side walls 28 which are opposite one another with respect to the median plane P. The side walls 28 are joined together by an end wall 30, directed substantially parallel to a transverse plane T, said transverse plane T being perpendicular to the median plane P and to the reference plane S. The bridge is U-shaped in profile: a wall 32, substantially parallel to the reference plane S of the component 20, joins the side walls 28 and the end wall 30 together. The wall 32 comprises an opening 34 intended to accept the clip.

The side walls 28 have, on their external face 36, a plurality of mutually parallel ribs 38 oriented in a transverse plane parallel to the plane T.

As has been depicted in FIGS. 3 and 4, the ribs 38 each have an end 40, projecting relative to an edge 42 of the side walls 28, said edge 42 being at the opposite end to the clip support wall 32. The edges 42 of the side walls 28 define a plane R substantially perpendicular to the median plane P.

However, in another embodiment that has not been depicted, the plane R could be not perpendicular to the median plane P, it being possible for the fastening means 24 not to exhibit symmetry with respect to the median plane P.

As has been depicted in FIGS. 3 and 5, the ends 40 of the ribs 38 are connected to the internal face 22 of the component 20 in such a way that a space 44 is left between the edge 42 and the internal face 22 of the component 20.

The ribs 38 have a profile that can be inscribed inside a triangle, one of the sides of which is connected to the internal face 22 of the component 20.

As has been depicted in FIG. 4, the ribs 38 are thinner at their region of connection to the internal face 22 of the component 20: thus an internal part 46 of the ribs 38 has a cutout 48, to make demolding easier.

The bridge 26 is therefore connected to the internal face 22 of the component 20 only by substantially isolated connecting regions formed by the ends 42 of the ribs 38.

Further, as depicted in FIGS. 2 and 3, in order to improve the shear strength of the fastening means in a direction corresponding to the line defined by the intersection between the median plane P and the reference plane S, an additional rib 46, oriented substantially parallel to the median plane P, may be provided in the continuation of the side walls 28. The additional ribs 46 are located near the end wall 32.

The molding of the component requires a mold (not depicted) comprising a sliding packing piece (not depicted) intended to be inserted inside the bridge 26.

As depicted in FIG. 3, to make the packing piece easier to demold, the plane R formed by the edges 42 of the side walls 28 makes an angle a with the reference plane S of the component 20.

Moreover, the ribs 38 are punch formed by the molding cavity rather than via the packing piece, and this presents a number of advantages:

the bearing surface upon which the packing piece rests in the housing formed in the bridge 26 is greater, making it possible to limit deformations associated with the injection-molding pressures,

the withdrawal stresses on the packing piece are lower allowing easier demolding without stress on the component 20,

the ribs 38 allow the component 20 to be held in position in the mold while the packing piece is being removed.

The trim component 20 according to the invention therefore exhibits fewer appearance defects such as rippling or shrinkage marks, for example, but also such as the traces of flow that may appear behind the packing piece.

Furthermore, the pull-out strength of the fastening means is improved.

1-7. (canceled)

8. A trim component made of injection-molded plastic, comprising:
a substantially planar part directed along a reference plane, an internal face of which comprises at least one fastening means, the fastening means comprises a bridge of median plane, configured to support a clip and including two side walls that are opposite one another with respect to the median plane and joined together by a clip support wall,
wherein the side walls of the bridge comprise, on their external faces, ribs with one end of which extends as a projection with respect to a plane defined by an edge of the side walls which is at the opposite end to the clip support wall and is connected to the internal face of the trim component such that a space is left between the plane and the internal face of the trim component.

9. The trim component as claimed in claim 8, wherein the ribs are oriented in transverse planes that are substantially perpendicular to the median plane and to the reference plane.

10. The trim component as claimed in claim 8, wherein the side walls are joined together by an end wall, a space being left between one edge of the end wall and the internal face of the component.

11. The trim component as claimed in claim 8, wherein the ribs are thinner in their region of connection to the internal face of the trim component, an internal part of the ribs exhibiting a cutout.

12. The trim component as claimed in claim 8, wherein the side walls of the bridge are extended by an additional rib oriented substantially parallel to the median plane.

13. The trim component as claimed in claim 12, wherein the additional rib is positioned near the end wall.

14. The trim component as claimed in claim 8, wherein the plane defined by the edges of the side walls forms an angle with the reference plane of the component, to make demolding easier.
